(19) United States
(12) Patent Application Publication
(10) Pub. No.: US 2023/0238876 A1
(43) Pub. Date: Jul. 27, 2023

(54) ELECTRICAL POWER CONVERTER

(71) Applicant: PRODRIVE TECHNOLOGIES INNOVATION SERVICES B.V., Son en Breugel (NL)

(72) Inventors: Daifei ZHANG, Zurich (CH); Mattia GUACCI, Prüm (DE); Johann Walter KOLAR, Zurich (CH); Jordi EVERTS, Son en Breuge (NL)

(21) Appl. No.: 17/997,166

(22) PCT Filed: Apr. 28, 2021
(86) PCT No.: PCT/EP2021/061203

§ 371 Date: Oct. 26, 2022

(30) Foreign Application Priority Data
Apr. 28, 2020 (EP) 20171937.4
Jul. 6, 2020 (NL) 2026008

(51) Int. Cl. H02M 1/12; H02M 7/219; H02M 3/158; H02M 7/797; H02M 1/00

(52) U.S. Cl. CPC H02M 1/123; H02M 1/0048; H02M 3/158; H02M 7/219; H02M 7/797; H02P 27/06

(57) ABSTRACT

An AC-DC converter may include three phase terminals, two DC terminals, a first converter stage to convert between an AC current at the phase terminals and a first DC current at the first and second intermediate nodes, a second converter stage operable to convert between a first DC signal at third and fourth intermediate nodes and a second DC signal at the DC terminals, a first filter stage comprising a capacitor network having a star-point, a DC link connecting the first intermediate node to the third intermediate node and the second intermediate node to the fourth intermediate node. The second converter stage includes a middle voltage node between the DC terminals and a boost circuit having a midpoint node at the same electrical potential as the middle voltage node. The DC link includes a common mode filter having a common mode capacitor connecting the middle voltage node to the star-point.

### TECHNICAL FIELD

The present disclosure is related to electrical converters allowing to convert between a three phase AC signal and a DC signal. The electrical converter comprises an AC/DC stage and a DC/DC stage.

### INTRODUCTION

High power and high efficiency battery chargers, enabling fast charging of electric vehicles (EVs), are of crucial importance for a fast growth of the EV market. Moreover, in case EV batteries serve as distributed energy storage elements to support the grid operation, EV chargers must allow bidirectional power conversion. The AC/DC front-end is a main element of an EV battery charging system, and must cover a wide output voltage range to adapt to different battery voltages.

Three-phase buck-boost rectifiers are known. The buck-boost topology is simply a buck rectifier with a boost-stage added at the output end of the inductor, as illustrated in Fig. 6.5 in [3]. The two input switches rectify the AC line into a switched voltage, converted next into a DC current by the high-frequency inductor. The output switch then feeds this current into the load.

In [4], a three-phase buck-boost current source inverter is described, comprising a buck-type DC/DC converter input stage and a boost-type three-phase current DC-link inverter output stage. The current source inverter is implemented with two different modulation schemes, namely conventional pulse-width modulation and two-third pulse-width modulation (⅔-PWM). The ⅔-PWM reduces conduction and switching losses and can be applied in a subset of the buck-mode operation region. In the remainder of the buck-mode operation region, conventional PWM (3/3-PWM) and ⅔-PWM are alternated depending on the instantaneous value of the output voltage.

References:
C. A. Bendall and W. A. Peterson, An EV On-Board Battery Charger, in Proc. of the IEEE Applied Power Electronics Conference and Exposition (APEC), San Jose, CA, USA, 1996.
US 2012/0286740, S. Loudot, B. Briane, O. Ploix, and A. Villeneuve, Fast Charging Device for an Electric Vehicle.
K. D. T. Ngo, Topology and Analysis in PWM Inversion, Rectification, and Cycloconversion, Ph.D. dissertation, California Institute of Technology, May 1984.
M. Guacci, D. Zhang, M. Tatic, D. Bortis, J. W. Kolar, Y. Kinoshita, H. Ishida, Three-Phase Two-Third-PWM Buck-Boost Current Source Inverter System Employing Dual-Gate Monolithic Bidirectional GaN e-FETs, CPSS Transactions on Power Electronics and Applications, vol. 4, no. 4, pp. 339-354, December 2019.
M. Baumann, J. W. Kolar, A Novel Control Concept for Reliable Operation of a Three-Phase Three-Switch Buck-Type Unity-Power-Factor Rectifier With Integrated Boost Output Stage Under Heavily Unbalanced Mains Condition, IEEE Transactions on Industrial Electronics, vol. 52, no. 2, pp. 399-409, April 2005.
Q. Lei, B. Wang, and F. Z. Peng, Unified Space Vector PWM Control for Current Source Inverter, in Proc. of the IEEE Energy Conversion Congress and Exposition (ECCE USA), Raleigh, NC, USA, 2012.
D. Menzi, D. Bortis, J. W. Kolar, Three-Phase Two-Phase-Clamped Boost-Buck Unity Power Factor Rectifier Employing Novel Variable DC Link Voltage Input Current Control, Proceedings of the 2^{nd} IEEE International Power Electronics and Application Conference and Exposition (PEAC), Shenzhen, China, November 4-7, 2018.
CH 698490, J. W. Kolar, Vorrichtung zur Regelung der Teilausgangsspannungen eines Dreipunkt-Hochsetzstellers.

### SUMMARY

There is a need in the art to provide a buck-boost electrical converter of the above-described kind, allowing an extended converter output voltage range. There is a need in the art to provide such an electrical converter allowing improved suppression of noise at the DC-side.

According to a first aspect of the present disclosure, there is therefore provided an electrical converter as set out in the appended claims.

An electrical converter according to the present disclosure comprises at least three phase terminals, a first DC terminal and a second DC terminal, a first converter stage and a second converter stage, and a DC link connecting the first and second converter stages.

The first converter stage is operably coupled to the at least three phase terminals and comprises a first intermediate node and a second intermediate node, wherein the converter stage is operable to convert between an AC current at the at least three phase terminals and a first DC current at the first and second intermediate nodes. The first converter stage is advantageously implemented as a buck-type bridge converter, advantageously as a current-source converter, in particular a (bidirectional) current-source rectifier.

The second converter stage is operably coupled to the first DC terminal and the second DC terminal and comprises a third intermediate node and a fourth intermediate node. The second converter stage is operable to convert between a first DC signal, preferably a current signal, at the third and fourth intermediate nodes and a second DC signal, preferably a voltage signal, at the first and second DC terminals, wherein the second converter stage comprises a middle voltage node between the first and second DC terminals. The second converter stage is advantageously implemented as, or comprises, a boost circuit, in particular comprising a first boost circuit and a second boost circuit series stacked between the first DC terminal and the second DC terminal. The second converter stage, e.g. the boost circuit comprises a plurality of first (active) switches series connected between the third intermediate node and the fourth intermediate node. By way of example, the first boost circuit comprises at least a first one of the first switches and the second boost circuit comprises at least a second one of the first switches. Advantageously, the middle voltage node is or acts as a common node of the first and second boost circuits, e.g. the middle voltage node and the common node (midpoint) of the first and second boost circuits are coincident or connected, e.g. through a direct link, so as to be at a same electrical potential. Either one, or both the first boost circuit and the second boost circuit can be a multi-level boost circuit comprising at least three voltage nodes.

The DC link connects the first intermediate node to the third intermediate node, and the second intermediate node to the fourth intermediate node. The electrical converter further comprises a first filter stage comprising a capacitor network operably coupled to each of the three phase terminals, wherein the capacitor network comprises a star-point. The DC link comprises a common mode filter, the common mode filter comprising a common mode capacitor connecting the middle voltage node to the star-point. Advantageously, the common mode filter comprises a common mode filter choke operably coupled to the first intermediate node and the second intermediate node, the third intermediate node and the fourth intermediate node. Advantageously, the DC link comprises at least one differential mode inductor operably coupled to the first intermediate node and the third intermediate node and/or operably coupled to the second intermediate node and the fourth intermediate node.

The electrical converter topology according to the present disclosure combines one or more of the following advantages. First, a three-level second converter stage is employed to extend the converter output voltage range without compromising its performance, but instead reducing the occurring switching losses and/or minimizing the number of magnetic components and the size of the DC-link inductor. Second, a novel integrated common mode (CM) filter is applied to suppress the CM noise at the DC-side.

Advantageously, the control structure is capable to seamlessly transition between conventional 3/3-PWM and ⅔-PWM [6].

As an advantage, the electrical converter according to aspects of the present disclosure can be implemented with a control structure as discussed in this document capable to automatically select the optimal operating modes for different output voltage values. Compared to the conventional voltage source approach, the converter system introduced herein offers several advantages, i.e. a reduction of switching losses enabled by a variable DC-link current control strategy (synergetic control) and by a sinusoidally varying switched voltage.

Accordingly, in one advantageous aspect, the present disclosure provides a three-phase current DC-link split-output buck-three-level-boost AC/DC converter, formed by a three-phase buck-type current source rectifier (CSR)-stage and a subsequent boost-type DC/DC-stage. This power converter is advantageously bidirectional and can operate under non-ideal three-phase mains conditions, e.g., in case of harmonics distortion, over- or under-voltage events, voltage dips and phase voltage interruptions. Moreover, both stages are advantageously operated synergetically to provide a wide output voltage range. Electrical converters according to the present disclosure are as well applicable in non-isolated on-board chargers protected by an on-board ground fault circuit interrupter [1]. In this case, the switches of the traction inverter and the stator coils of the motor, already present on-board of the EV, can be used as DC/DC-stage and DC-link inductor, respectively, aiming for a compact and low-cost solution [2].

Furthermore, this disclosure can also be applied to other areas requiring a three-phase AC/DC PFC rectifier front-end either for providing a widely adjustable DC output/load voltage from a constant three-phase mains or for providing a constant DC output voltage despite a large tolerance of the mains voltage. An example for the latter case would be datacenter power supplies, which (besides wide input voltage range) should feature continuous power supply and sinusoidal input current also in case of a mains phase loss which is possible due to the boost output stage of the proposed system. Moreover, the system could be employed for supplying a non-isolated converter stage supplying a single-side grounded load, as frequently given for envelope tracking power supplies of linear amplifiers, e.g. used for testing purposes.

Finally, it should be highlighted, that actually two individually controlled DC outputs are generated, which could be different in reference voltage values and power delivery to the individual loads, i.e. the total power taken from the three-phase can be freely distributed to the two outputs. Accordingly, e.g. two isolated DC/DC load converters could be supplied from the two DC outputs, which would allow a design with power semiconductors of lower voltage rating and the utilization of transformers with lower turns ratio in case a low output voltage needs to be generated like for telecom applications.

According to a second aspect of the disclosure, there is provided an electric motor drive system as set out in the appended claims.

According to a third aspect of the disclosure, there is provided a battery charging system as set out in the appended claims.

According to a fourth aspect of the disclosure, there is provided a method of converting between an AC signal having at least three phases at three or more phase nodes and a DC signal at a high node and a low node. The method comprises switching by pulse width modulation between the at least three phase nodes and the high node and the low node to obtain a switched voltage signal across the high node and low node. A period of the switched voltage signal comprises a zero voltage level portion obtained by connecting the phase node having a smallest absolute instantaneous voltage value of the at least three phases of the AC signal to both the high node and the low node. The method reduces the common mode noise generated by the PWM switching without increasing switching losses or degrading a differential mode performance. Advantageously, the switched voltage signal comprises a second voltage level portion obtained by connecting the phase node having the highest instantaneous voltage value of the at least three phases of the AC signal to the high node, and connecting the phase node having the lowest instantaneous voltage value of the at least three phases of the AC signal to the low node. Advantageously, the switched voltage signal comprises a third voltage level portion obtained by connecting the phase node having the smallest absolute instantaneous voltage value to the high node, and connecting the phase node having the lowest instantaneous voltage value of the at least three phases of the AC signal to the low node, or vice versa.

According to a fifth aspect of the disclosure, there is provided a method of converting between an AC signal having at least three phases at three or more phase nodes and a DC signal at a high node and a low node. The method comprises switching by pulse width modulation between the at least three phase nodes and the high node and the low node to convert between the AC signal and the DC signal. The switching comprises switching between active states in which a connection is made between two of the at least three phases and the high node and the low node and zero states in which the high node and the low node are short circuited, in particular in which both high and low node are both connected to only one of the at least three phases. At least one, preferably all the zero states are obtained by connecting a phase of the at least three phases of the AC signal having a smallest absolute instantaneous voltage value to the high and low nodes.

The fourth and fifth aspects described above can be provided independently of the first to third aspects, or in combination. In particular, the fourth and fifth aspects can be implemented in the electrical converter according to the first aspect.

### BRIEF DESCRIPTION OF THE DRAWINGS

Aspects of the disclosure will now be described in more detail with reference to the appended drawings, wherein same reference numerals illustrate same features and wherein:

FIG. 1 represents a schematic of an exemplary embodiment of an electrical converter according to the present disclosure implemented as a three-level (3-L) three phase (3-Φ) buck-boost (bB) current DC-link AC/DC converter system. To filter the common mode (CM) noise at the DC output port, the artificial 3-Φ neutral point k and the DC midpoint m are connected through a CM filter capacitor C_{CM}.

FIG. 2 represents Operating regions of the proposed 3-L 3-Φ bB current DC-link AC/DC converter system of FIG. 1. Depending on the required output voltage Vₒᵤₜ, different operating modes, i.e. Buck-Mode, Transition-Mode, and Boost-Mode (#1 or #2), are applied in order to minimize the switching and conduction losses, and reduce the CM noise emission. Different color intensity indicate different output power levels.

FIGS. 3a-d represent simulated waveforms of the converter of FIG. 1 operating in Buck-Mode with a capacitive return connection. In particular, in FIG. 3a the three-phase mains voltages vₐ, v_{b}, and v_{c}, in FIG. 3b the three-phase mains currents iₐ, i_{b}, and i_{c}, the DC-link currents i_{DC,p} and i_{DC,n} and the CM current on the return connection i_{CM}, in FIG. 3c the output voltage vₒᵤₜ and the output capacitor voltages v_{cout,p} and v_{cout,n}, and in FIG. 3d the three-phase mains line-to-line voltages v_{ab}, v_{bc}, and v_{ca} are shown.

FIG. 4 represents differential mode (DM) voltages in Buck-Mode operation over one 60°-wide sector of the mains period defined by the three-phase mains currents, i.e. in this sector phase c has the minimum current value. In particular, vₚₙ is a switched waveform alternately assuming the values of two line-to-line voltages v_{ac} and v_{bc} during the active states, and of 0V during the zero state, and v_{qr} is equal to Vₒᵤₜ. The graphs in the upper part offer a zoomed view of typical voltage waveforms within a switching period.

FIG. 5a represents the CM voltage of the converter of FIG. 1 operating in the Buck-Mode according to an aspect of the present disclosure, with the capacitive return connection as described in the present disclosure.

FIG. 5b represents the CM voltage of a converter as in FIG. 1 operating in Buck-Mode as described herein without the return connection that is contemplated in the present disclosure (the white dotted line indicates the local average value (within one pulse period) of the switched voltage waveform v_{CM}).

FIG. 6 represents common mode (CM) voltages in Buck-mode operation of the converter of FIG. 1 over one 60°-wide sector of the mains period defined by the three-phase mains currents, i.e. in this sector phase c has the minimum current value. specifically, the CM voltage generated by the CSR-stage v_{CM,CSR} constituted of two active states common mode voltages

$${v}_{C M , b c} = \frac{{v}_{b} + {v}_{c}}{2}$$

and

$${v}_{C M , a c} = \frac{{v}_{a} + {v}_{c}}{2}$$

and one phase voltage vₐ or v_{b}, and low-frequency components of the generated CM voltage v_{CM,LF}. The graphs in the upper part offer a zoomed view of typical voltage waveforms during two switching periods.

FIG. 7 represents space vector diagram of a three-phase current DC-link converter highlighting the nine states of the three-phase rectifier. The 60°-wide sector considered in FIG. 3d is shaded.

FIGS. 8a-d represent simulated waveforms of the converter of FIG. 1 operating in Boost-Mode with a capacitive return connection. In particular, in FIG. 8a the three-phase mains voltages vₐ, v_{b}, and v_{c}, in FIG. 8b the three-phase mains currents iₐ, i_{b}, and i_{c}, the DC-link current i_{DC,p} and i_{DC,n} and the CM current in the return connection i_{CM}, in FIG. 8c the output voltage vₒᵤₜ and the output capacitor voltages v_{cout,p} and v_{cout,n}, and in FIG. 8d the three-phase mains line-to-line voltages v_{ab}, v_{bc}, and v_{ca} are shown.

FIG. 9 represents DM voltages in Boost-Mode #1 operation over one 60°-wide sector defined by the three-phase mains currents, i.e. in this sector phase c has the minimum current value. In particular, vₚₙ is a switched waveform alternately assuming the values of two line-to-line voltages v_{ac} and v_{bc} during the active states, while v_{qr} switches between

$$\frac{{V}_{o u t}}{2}$$

and Vₒᵤₜ. The graphs in the upper part offer a zoomed view of typical voltage waveforms within a switching period T_{sw}.

FIG. 10a represents the CM voltage v_{CM} of the converter of FIG. 1 operating in Boost-Mode #1 with the return connection according to the disclosure.

FIG. 10b represents the CM voltage v_{CM} of a converter as in FIG. 1 operating in Boost-Mode #1 without the return connection that is contemplated in the present disclosure (the white dot line indicates the local average value of the switched voltage waveform v_{CM}).

FIG. 11 represents CM voltages in Boost mode #1 operation over a 60°-wide sector defined by the three-phase mains currents, i.e. in this sector phase c has the minimum current value. Specifically, CM voltage generated by the CSR-stage v_{CM,CSR} constituted of the CM voltages of two active states

$${v}_{C M , b c} = \frac{{v}_{b} + {v}_{c}}{2}$$

and

$${v}_{C M , a c} = \frac{{v}_{a} + {v}_{c}}{2}$$

and low-frequency components of the generated CM voltage v_{CM,LF}. Furthermore, the CM voltage generated by the DC/DC-stage v_{CM,DCDC} formed by

$$\pm \frac{1}{4} {V}_{o u t}$$

and 0V is demonstrated. The graphs in the upper part offer a zoomed view of typical voltage waveforms during two switching periods.

FIG. 12 represents DM voltages in Boost-Mode #2 operation over one 60°-wide selected sector defined by the three-phase mains currents, i.e. in this sector phase c has the minimum current value. In particular, vₚₙ is a switched waveform alternately assuming the values of two line-to-line voltages v_{ac} and v_{bc} during the active states, while v_{qr} switches between

$$\frac{{V}_{o u t}}{2}$$

and Vₒᵤₜ, or

$$\frac{{V}_{o u t}}{2}$$

and 0V depending on the local average value of vₚₙ. The graphs in the upper part offer a zoomed view of typical voltage waveforms within a switching period T_{sw}.

FIG. 13a represents the CM voltage of the converter of FIG. 1 operating in Boost-Mode #2 with the return connection according to the disclosure.

FIG. 13b represents the CM voltage of a converter as in FIG. 1 operating in Boost-Mode #2 without the return connection that is contemplated in the present disclosure (the white dotted line indicates the local average value of the switched voltage waveform v_{CM}).

FIG. 14 represents CM voltages in Boost mode #2 operation over a 60°-wide selected sector defined by the three-phase mains currents, i.e. in this sector phase c has the minimum current value. Specifically, CM voltage generated by the CSR-stage v_{CM,CSR} constituted of the CM voltages of two active states

$${v}_{C M , b c} = \frac{{v}_{b} + {v}_{c}}{2}$$

and

$${v}_{C M , a c} = \frac{{v}_{a} + {v}_{c}}{2}$$

and low-frequency components of the generated CM voltage v_{CM,LF}. Furthermore, the CM voltage generated by the DC/DC-stage v_{CM,DCDC} formed by

$$\pm \frac{1}{4} {V}_{o u t}$$

and 0V is demonstrated. The graphs in the upper part offer a zoomed view of typical voltage waveforms during two switching periods.

FIGS. 15a-d represent simulated waveforms of the converter of FIG. 1 operating in Transition-Mode with a capacitive return connection. In particular, in FIG. 15a the three-phase mains voltages vₐ, v_{b}, and v_{c}, in FIG. 15b the three-phase mains currents iₐ, i_{b}, and i_{c}, the DC-link current i_{DC,p} and i_{DC,n} and the CM current on the return connection i_{CM}, in FIG. 15c the output voltage vₒᵤₜ and the output capacitor voltages v_{cout,p} and v_{cout,n}, and in FIG. 15d the voltage vₘₖ across the CM capacitor C_{CM} are shown.

FIG. 16 represents a synergetic control structure according to an exemplary embodiment includes three main blocks, i.e. the Output Voltage Control, the DCLink Current Reference Generation and the Synergetic DC-Link Current Control, enabling PFC operation with sinusoidal three-phase mains currents iₐ, i_{b}, and i_{c} in phase with the sinusoidal three-phase mains voltages v_{m,a}, v_{m,b}, and v_{m,c}, regulation of the output voltage Vₒᵤₜ, control of the DC-link current i_{DC} with synergetic operation of the three-phase buck CSR-stage and of the boost DC/DC-stage, and seamless transition between the different operating modes, i.e. Buck- and Boost-mode, and modulation schemes, i.e. 3/3-PWM and ⅔-PWM.

FIG. 17a represents a CM/DM equivalent circuit of the electrical converter of FIG. 1, in which the CSR-stage and the DC/DC-stage are replaced by switched voltage sources.

FIG. 17b represents a CM/DM equivalent circuit of the electrical converter of FIG. 1, in which the CSR-stage and the DC/DC-stage are replaced by equivalent CM/DM voltage sources.

FIG. 18 represents another exemplary embodiment of an electrical converter according to the present disclosure, which differs from the converter of FIG. 1 in that the second converter stage (DC/DC stage) is implemented as a flyback capacitor circuit.

FIG. 19 represents a battery charging system according to aspects of the present disclosure.

FIG. 20 represents an electric motor drive system according to aspects of the present disclosure.

### DETAILED DESCRIPTION

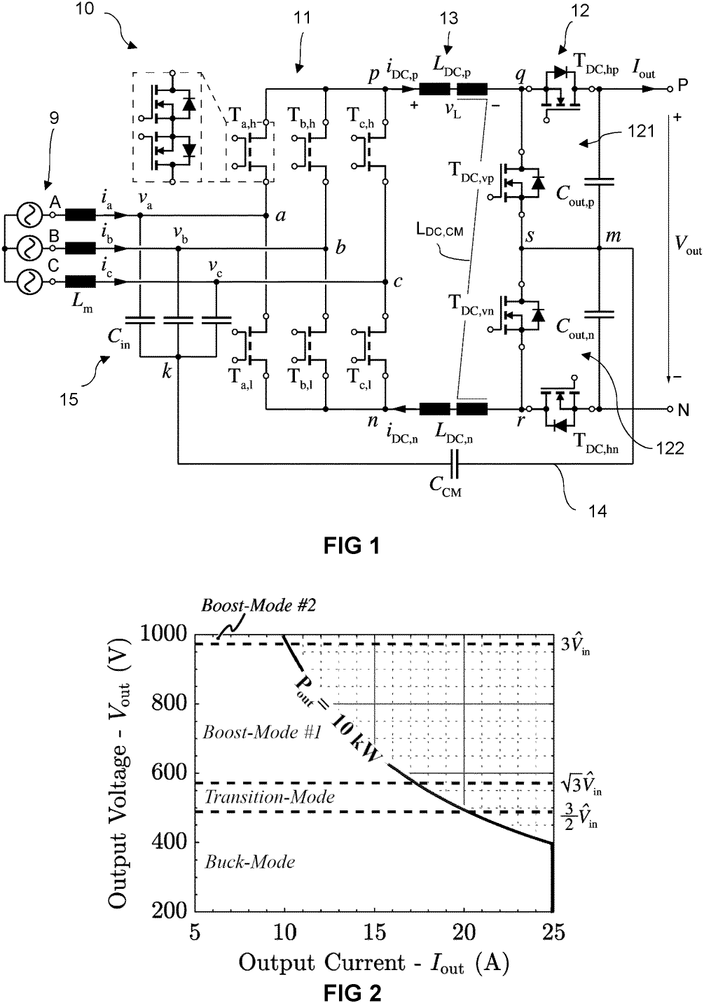

Referring to FIG. 1, an embodiment of an electrical converter 10 according to aspects of the present disclosure is implemented as a three-phase (3-Φ) current DC-link split-output buck-three-level-boost current AC/DC converter system, comprising a 3-Φ buck-type current source rectifier (CSR)-stage 11 and a subsequent three-level (3-L) boost-type DC/DC-stage 12. The CSR stage 11 comprises six semiconductor switches T_{a,h}, T_{a,l}, T_{b,h}, T_{b,l}, T_{c,h}, T_{c,l} having bidirectional voltage blocking capability, advantageously arranged in three bridge legs, and operable to switchingly connect the AC voltage nodes a, b, c to the DC nodes p, n. Each of these semiconductor switches can be formed by anti-series connecting two discrete semiconductor switches having unidirectional voltage blocking capability, possibly with external anti-parallel diodes. Alternatively, the semiconductor switches of the CSR stage 11 can be formed as monolithic bidirectional GaN field effect transistors, in particular enhanced-mode field effect transistors (e-FET).

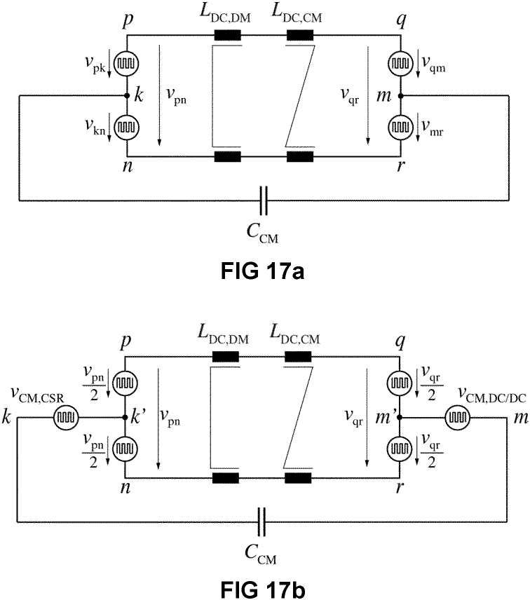

The DC/DC stage 12 advantageously comprises an upper boost circuit 121 and a lower boost circuit 122 stacked between the DC terminals P and N. The upper and lower boost circuits 121, 122 comprise a common node s connected to the middle voltage node m such that nodes s and m are at a same electrical potential. Each of the upper and lower boost circuits can be implemented with semiconductor switches T_{DC,vp} and T_{DC,hp} for the upper boost circuit 121 and semiconductor switches T_{DC,vn} and T_{DC,hn} for the lower boost circuit 122. Other implementations are possible. By way of example, either one or both the upper and lower boost circuits can be implemented as a flyback capacitor circuit 123, 124 as shown in FIG. 18. FIG. 18 also shows the possibility of utilizing the middle voltage node m as a third DC terminal 125.

A DC-link 13 connects the CSR stage 11 and the DC/DC stage 12. In particular, the DC-link 13 connects the DC-nodes p, n of the CSR stage 11 to the input nodes q, r of the DC/DC stage 12. The DC-link 13 is implemented with a novel common mode (CM) filtering concept, comprising a capacitive return connection 14 between the input capacitors Cᵢₙ (star-point k) and the middle voltage node m of the output capacitors C_{out,p} and C_{out,n}, possibly in combination with a CM DC-link inductor L_{DC,CM}. This common mode filtering concept allows to significantly reduce the high-frequency components of CM noise.

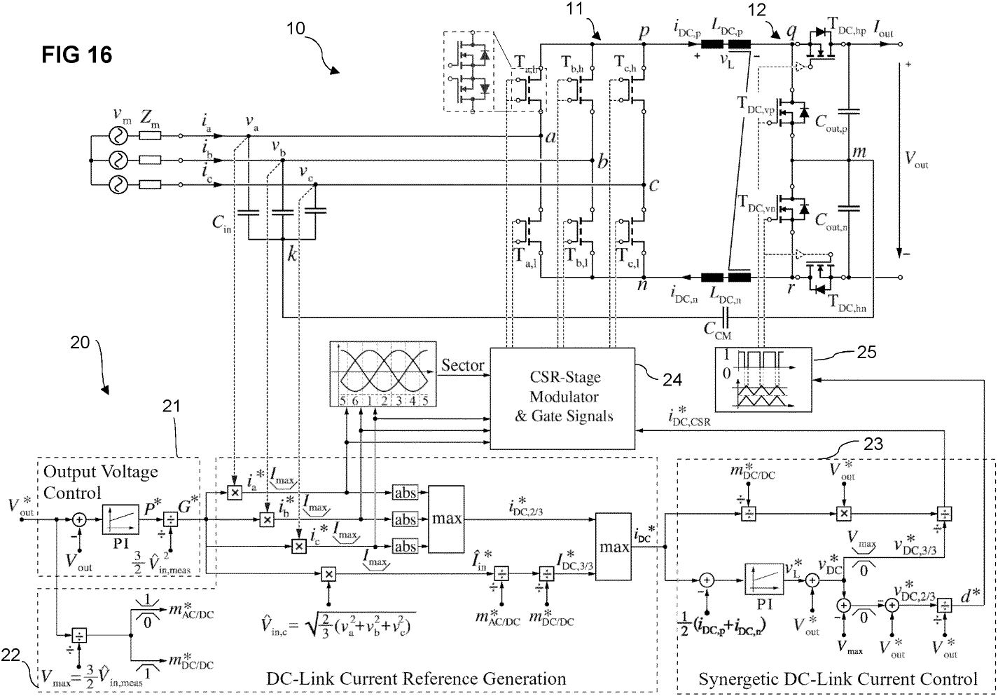

An input filter 15 is advantageously arranged between the AC terminals A, B, C and the AC voltage nodes a, b, c. The input filter can comprise a network of input capacitors Cᵢₙ which are advantageously star-point-connected to star-point k. Furthermore, the split-output structure advantageously enables an asymmetrical loading capability at the DC output-port. FIGS. 17a and b represent equivalent electrical circuits of the converter of FIG. 1. The DC-link 13 advantageously comprises a common mode inductor L_{DC,CM} and/or a differential mode inductor L_{DC,DM} which are operably coupled to nodes p and q and/or n and r.

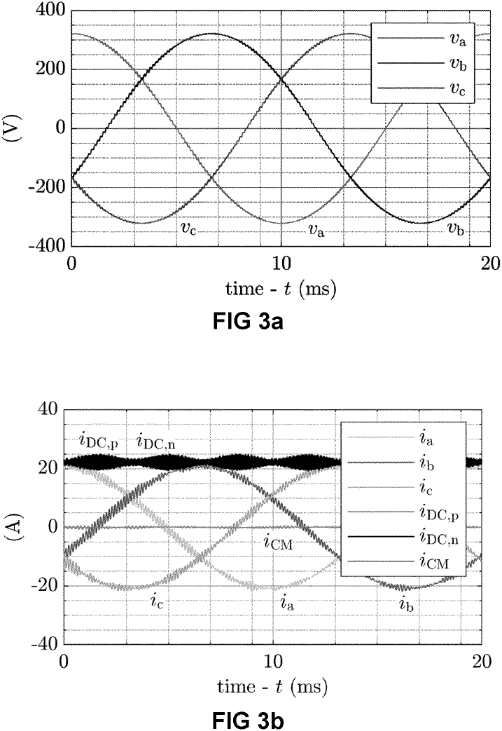

Different possible operating modes employed in the different output voltage regions characteristic of this converter (see FIG. 2) are analyzed in the following with the support of simulation results.

The converter operating modes as described herein advantageously implement two different pulse-width modulation schemes for operating the switches T_{a,h}, T_{a,l}, T_{b,h}, T_{b,l}, T_{c,h}, T_{c,l} of the CSR stage 11, namely conventional pulse-width modulation (3/3-PWM) and two-third pulse-width modulation (⅔-PWM). The electrical converter 10 comprises a control unit configured to automatically select which of the two PWM schemes to use for operating the CSR stage 11 based on a desired or requested output voltage, as will be described in more detail below.

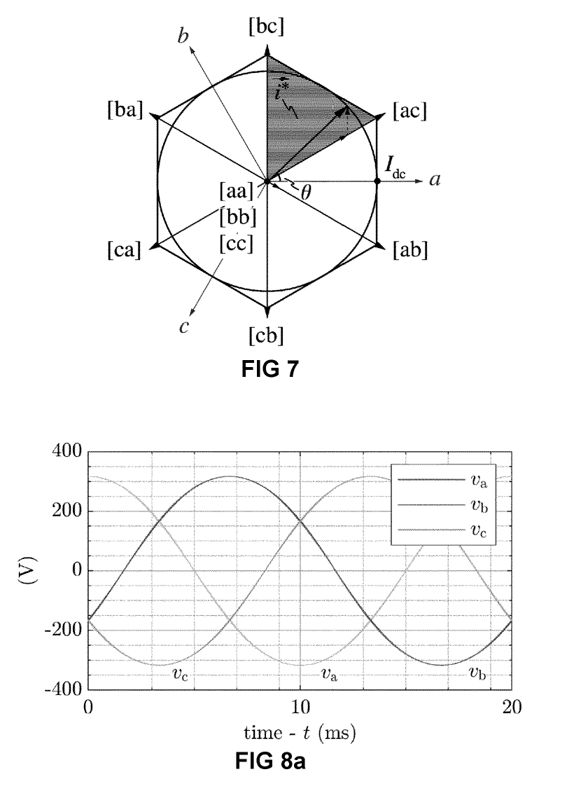

Referring to FIG. 7, six symmetric π/3-wide sectors of the AC input period are represented with six active states [bc], [ac], [ab], [cb], [ca] and [ba] and three freewheeling or zero states [aa], [bb] and [cc]. The letters ‘a’, ‘b’ and ‘c’ in the above refer to the voltage nodes a, b, c of FIG. 1. E.g., the state [bc] refers to a state in which node b is connected to node p by closing switch T_{b,h} and in which node c is connected to node n by closing switch T_{c,l}. Hence, in the active states, the AC input 9 is connected between the DC-link nodes p, n, whereas in the zero states, the nodes p and n are short circuited. Consequently, depending on the selected state, the DC-link input voltage vₚₙ varies between 0V (zero states) and the six input voltages ±v_{ab}, ±v_{bc} and ±v_{ac}.

In 3/3-PWM, the six semiconductor switches T_{a,h}, T_{a,l}, T_{b,h}, T_{b,l}, T_{c,h}, T_{c,l} of the CSR stage 11 are operated in order to switch between the two respective active states and the zero state. In the example of the shaded sector of FIG. 2, the switches of the CSR stage 11 are operated to switch between states [bc], [ac] and the zero state. Conventionally, the zero state [cc] is used for this sector. However, in one aspect of the present disclosure, as will be described below in relation to buck-mode operation, the zero state used in this sector is [bb] from

$$\frac{π}{6} \text{to} \frac{π}{3}$$

and [aa] from

$$\frac{π}{3} \text{to} \frac{π}{2} ,$$

instead of [cc] over the whole sector. This allows to further reduce the common mode noise generated by the CSR stage.

In ⅔-PWM, a pulse-width modulation scheme is employed that is free of zero states in all sectors, i.e. all zero space vectors are eliminated and only the active states are applied. For the shaded sector of FIG. 2, this results in that only active states [bc] and [ac] are applied, without applying the zero state, e.g. [cc]. Consequently, T_{c,h} is permanently off and only T_{a,h} and T_{b,h} are alternately switched. In this case, T_{c,l} is permanently on and T_{a,l} and T_{b,l} are permanently off. The ⅔-PWM scheme allows to improve efficiency by eliminating switching losses resulting from transitioning to/from the zero state and possibly conduction losses in the DC-link due to reduced RMS value of the DC-link current. Further details regarding ⅔-PWM scheme can be found in reference [6], section III.B and IV and in [4].

(I) Buck-Mode Operation

$$\left({V}_{o u t} < \frac{3}{2} {\hat{V}}_{i n}\right)$$

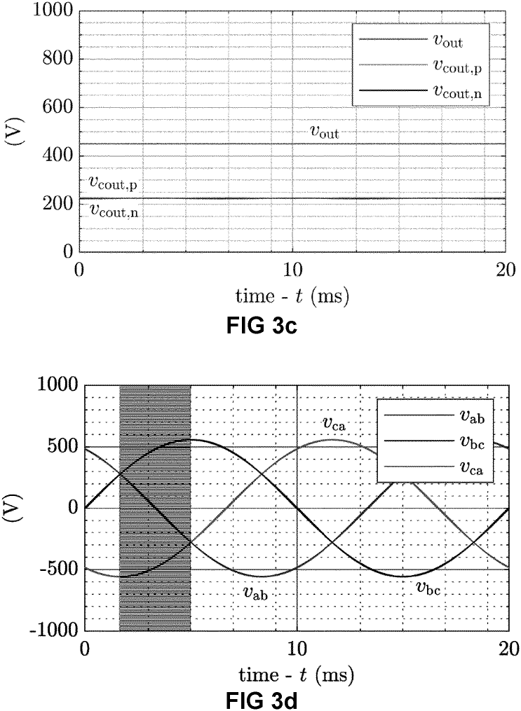

In buck-mode operation, the most significant waveforms of the CSR-stage and of the DC/DC-stage are reported in FIGS. 3a-d. In this mode, only the CSR-stage operates to step down the three-phase mains voltages to a DC output voltage lower than

$$\frac{3}{2} {\hat{V}}_{i n}$$

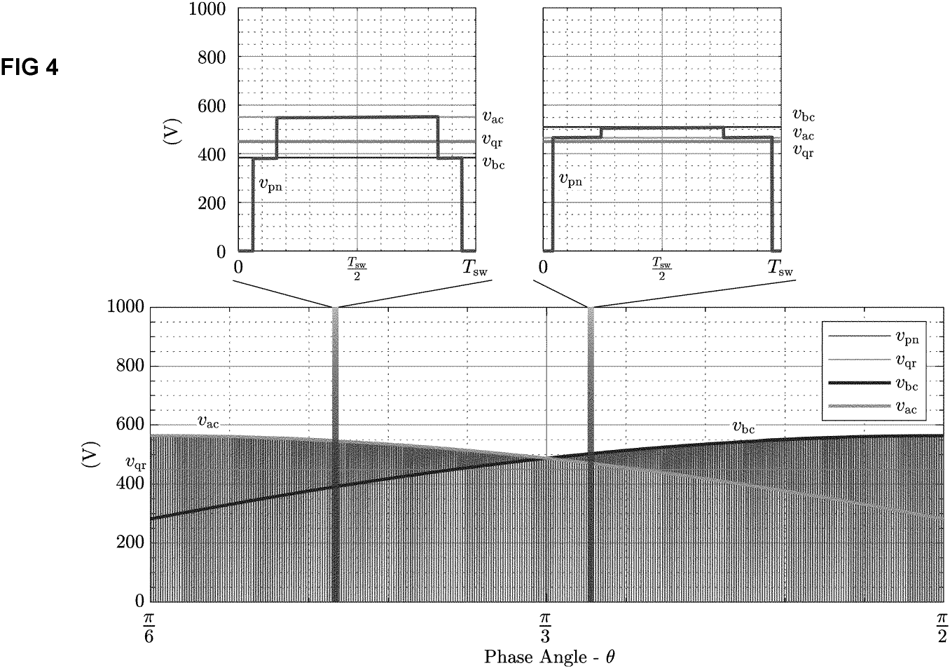

(where V̂ᵢₙ refers to the peak amplitude of the AC input voltage). The two switches T_{DC,hp} and T_{DC,hn} of the DC/DC-stage are permanently on to avoid any switching losses, as shown in FIG. 4, where v_{qr} = Vₒᵤₜ.

The differential mode (DM) output voltage of the CSR-stage vₚₙ is a switched waveform alternately assuming the values of two line-to-line voltages during the active states, and of 0V during the zero state, as shown in FIG. 4.

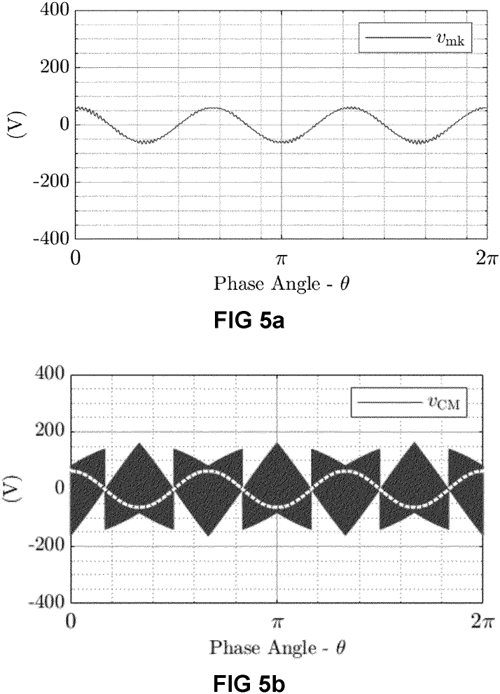

In FIGS. 5a-b, v_{CM,CSR} coincides with the CM voltage v_{CM} generated by the converter without the return connection 14, i.e. with an open circuit between m and k, due to permanently clamping of the DC/DC stage. With a capacitive return connection, i.e. a CM capacitor C_{CM} connected between m and k, C_{CM}, together with the CM DC-link inductor L_{DC}, forms a CM filter. Accordingly, the low-frequency (LF), i.e. 150 Hz, component of v_{CM} appears across C_{CM} (see FIG. 5a), while the high-frequency (HF) component, i.e. at the switching frequency, appears across L_{DC,p} and L_{DC,n}.

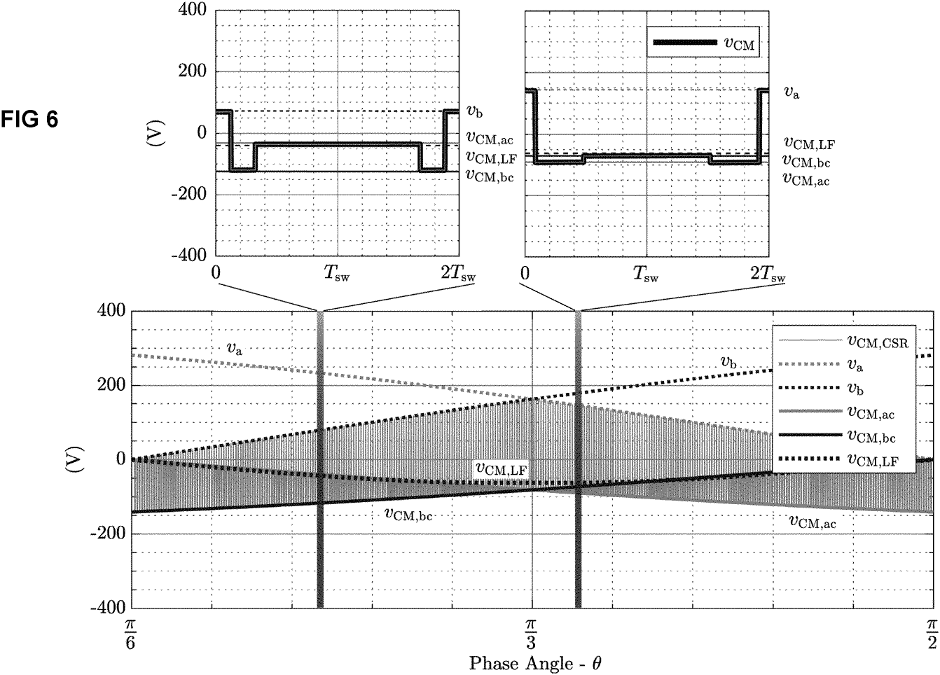

In buck-mode operation, a 3/3-PWM scheme is advantageously applied. To reduce the CM noise generated by the CSR-stage 11 without increasing switching losses or degrading the DM performance, e.g. the DC-link current ripple, the zero state is advantageously implemented by connecting the AC input voltage node a, b, c having the smallest absolute instantaneous voltage value to the nodes p, n of the DC-link 13. In FIG. 6, the sector where phase c has the minimum current value is considered as an example (this sector is shaded in FIG. 7). The zero state used in this sector is [bb] from

$$\frac{π}{6} \text{to} \frac{π}{3}$$

and [aa] from

$$\frac{π}{3} \text{to} \frac{π}{2} ,$$

instead of [cc] as in the PWM schemes described in literature (see FIG. 7).

The aforementioned PWM modulation scheme advantageously allows to have a continuous LF component of v_{CM} at the boundary between different sectors, in turn allowing implementation of the capacitive return connection 14. Thus, advantageously, in each sector, the LF component of v_{CM} should, for example, start from 0V and end at 0V. Otherwise, a current ringing will occur on the return path and also in the DC-link.

(II) Boost-Mode Operation

$$\left({V}_{o u t} > \sqrt{3} {\hat{V}}_{i n}\right)$$

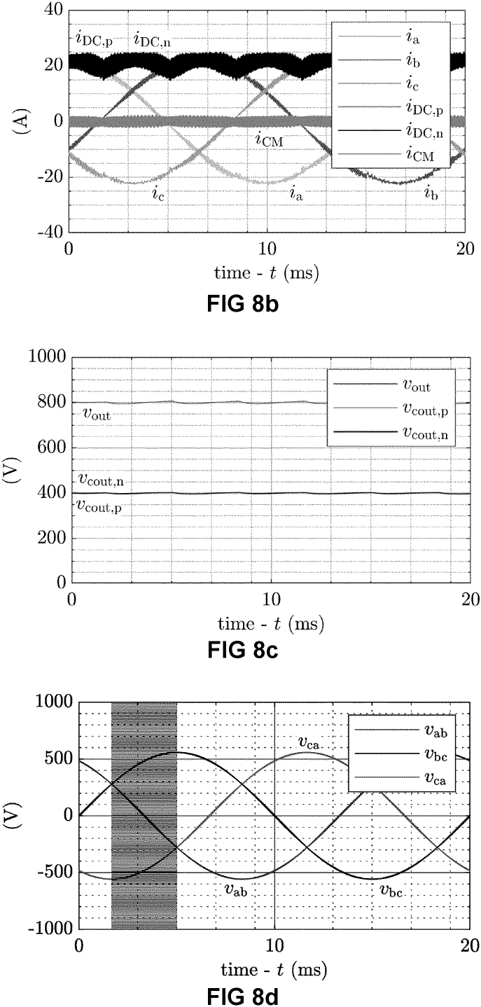

To achieve the boost functionality, both CSR-stage 11 and DC/DC-stage 12 are operated simultaneously. The CSR-stage 11 always operates at the maximum modulation index (equal to one) to minimize the DC-link current i_{DC} and the conduction losses of the whole converter 10. In boost-mode operation, a ⅔-PWM scheme is advantageously applied to the switches of the CSR stage 11. The DC-link current i_{DC} is controlled to a pulsed shape as shown in FIG. 8b. Depending on the local average value (averaged within one pulse period) of vₚₙ, the input voltage of the DC/DC-stage v_{qr} is a switched waveform alternately assuming the values of

$$\frac{{V}_{o u t}}{2}$$

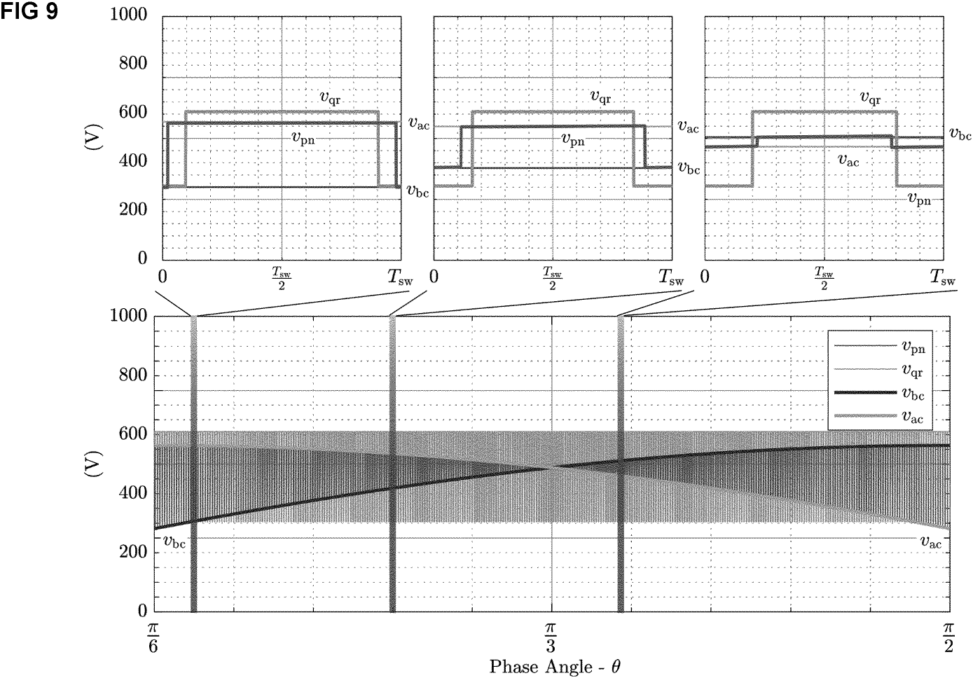

and Vₒᵤₜ (Boost-Mode #1, see FIG. 9), or 0V and

$$\frac{{V}_{o u t}}{2}$$

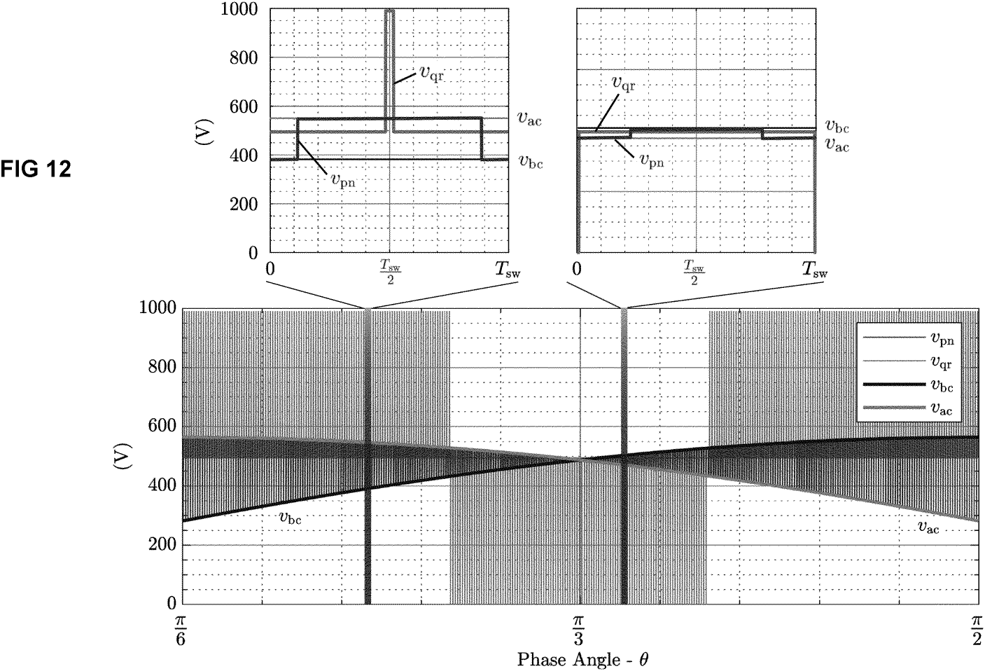

(Boost-Mode #2, see FIG. 12).

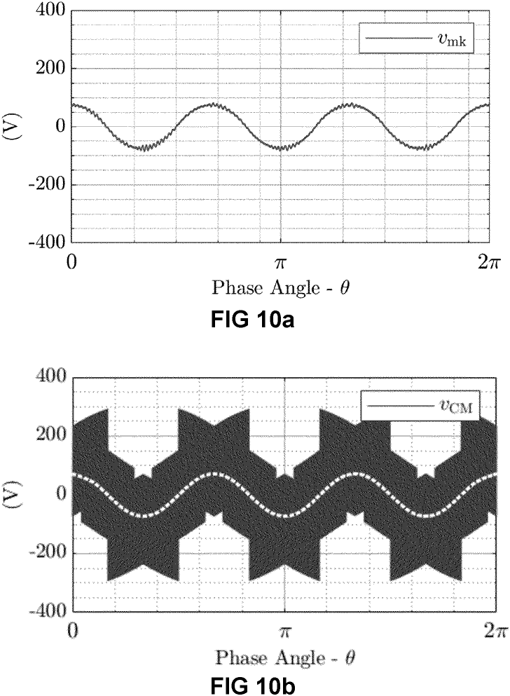

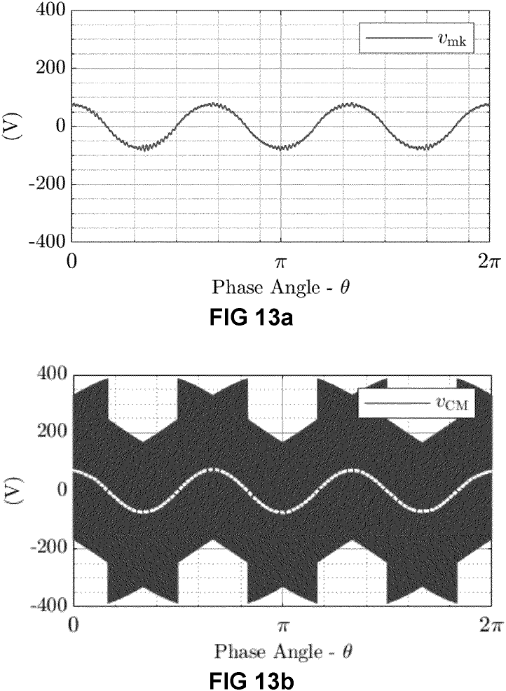

Furthermore, the converter CM voltage v_{CM} (for Boost-Mode #1 see FIG. 10b, and for Boost-Mode #2 see FIG. 13b) is generated by both the CSR-stage 11 and the DC/DC-stage 12, due to the operation of both stages in Boost-Mode.

Last but not least, the upper and lower output capacitors C_{out,p} and C_{out,n} are alternatively utilized when

$$\frac{{V}_{o u t}}{2}$$

is required at the input 12 of the DC/DC-stage to balance the output mid-point m. As a result, the main frequency component of v_{CM,DCDC} is at half of the switching frequency, while the one of v_{CM,CSR} is at the three times of the mains frequency.

(II.1) Boost-Mode #1

$$\left(3 {\hat{V}}_{i n} > {V}_{o u t} > \sqrt{3} {\hat{V}}_{i n}\right)$$

A three-level (3-L) DC/DC-stage 12 is advantageously considered allowing to extend the output voltage range and reduce the switching losses in the DC/DC-stage (as compared to a two-level arrangement). Due to a comparably low output voltage in the Boost-Mode #1, the input voltage of the DC/DC-stage v_{qr} is a switched waveform alternately assuming the values of

$$\frac{{V}_{o u t}}{2}$$

and Vₒᵤₜ (Boost-Mode #1, see FIG. 9).

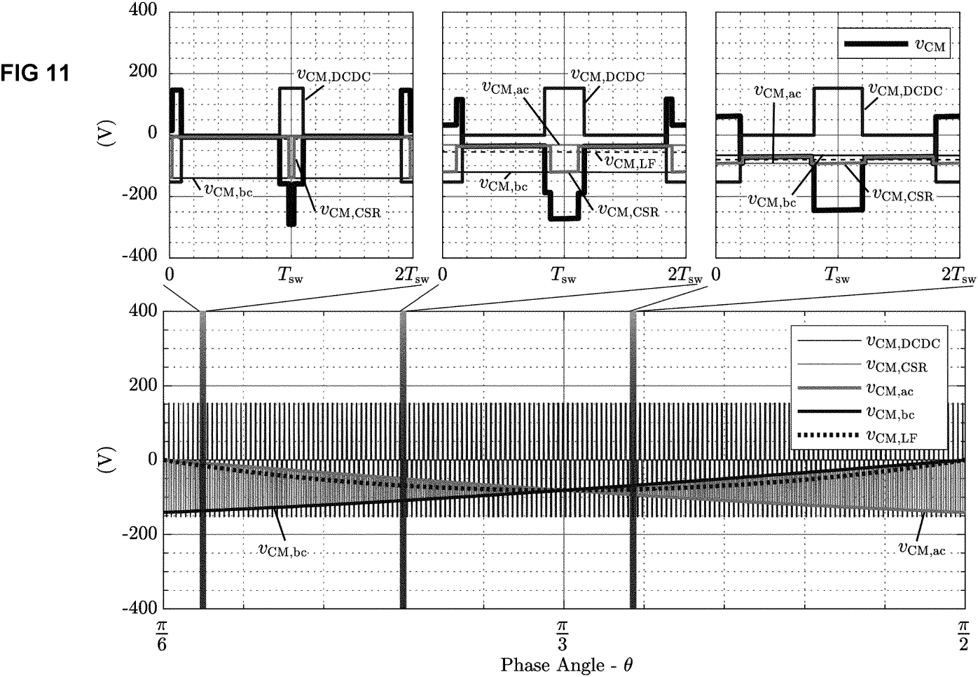

The CM voltage generated by the CSR-stage v_{CM,CSR} is a switched waveform alternately assuming the values of two CM voltages during the active states, as shown in FIG. 11. Advantageously, the LF component of v_{CM,CSR} is identical to the LF component of v_{CM}, which also satisfies the aforementioned requirement for the proposed CM filtering method. The DC/DC-stage only produces HF CM components, i.e. 0V if

$${v}_{\text{qr}} = 0 \text{V} \text{or} {V}_{\text{out}} , \frac{{V}_{o u t}}{4}$$

if T_{DC,hp} and T_{DC,vn} are on, and

$$- \frac{{V}_{o u t}}{4}$$

if T_{DC,hn} and T_{DC,vp} are on.

Considering the impact on CM and DM voltage-time area, the same carrier is advantageously used to generate the PWM signals of the CSR-stage 11 and of the DC/DC-stage 12, and the switching states featuring the larger values of two switched voltage waveforms vₚₙ and v_{qr} are centered in one switching period to ensure minimum CM and DM voltage-time area over the DC-link CM and DM inductors L_{DC,p} and L_{DC,n}, as shown in FIG. 9.

(II.2) Boost-Mode #2 (Vₒᵤₜ > 3V̂ᵢₙ)

Due to the increased Vₒᵤₜ, the input voltage of the DC/DC-stage v_{qr} is a switched waveform alternately assuming the values of 0V and

$$\frac{{V}_{o u t}}{2}$$

(Boost-Mode #2, see FIG. 12). When Vₒᵤₜ > 3V̂ᵢₙ, Vₒᵤₜ is large enough to balance the DM voltage-time area of the CSR-stage by only using 0V and

$$\frac{{V}_{o u t}}{2} ,$$

so Boost-Mode #2 is applied.

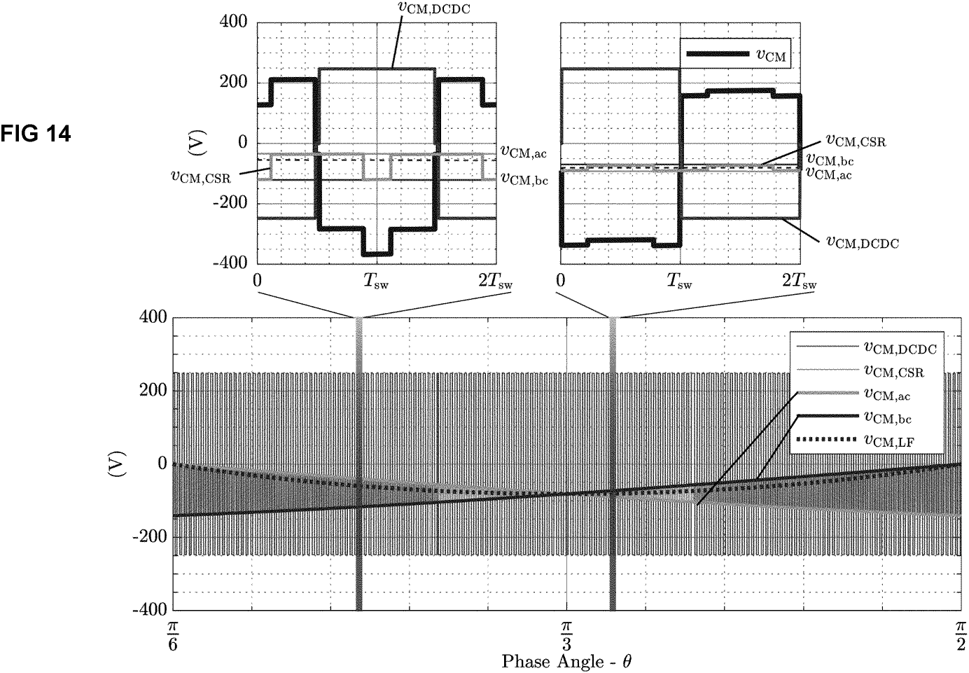

The CM voltage generated by the CSR-stage v_{CM,CSR} is a switched waveform alternately assuming the values of two CM voltages of the active states, as shown in FIG. 14. Advantageously, the LF component of v_{CM,CSR} is identical to the LF component of v_{CM}, which also allows to satisfy the aforementioned requirement for the selected CM filtering method. The DC/DC-stage only produces HF components, i.e. 0V if v_{qr}= 0V or Vₒᵤₜ,

$$\frac{{V}_{o u t}}{4}$$

if T_{DC,hp} and T_{DC,vn} are on, and

$$- \frac{{V}_{o u t}}{4}$$

if T_{DC,hn} and T_{DC,vp} are on.

(III) Transition-Mode Operation

$$\left(\frac{3}{2} {\hat{V}}_{i n} < {V}_{o u t} < \sqrt{3} {\hat{V}}_{i n}\right)$$

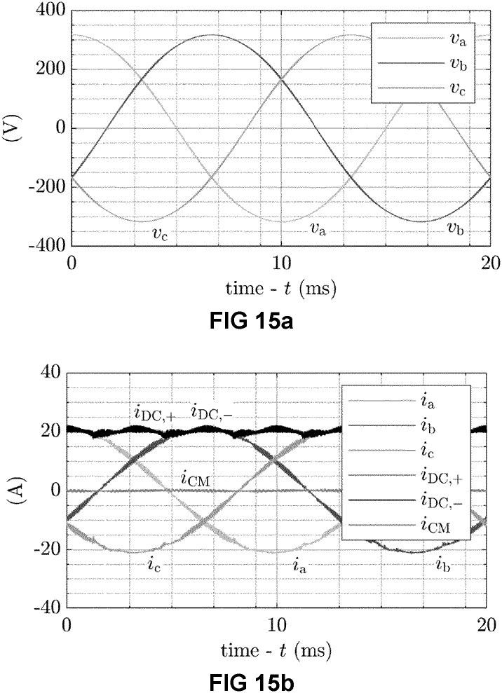

In Transition-Mode, 3/3-PWM and ⅔-PWM are alternately applied based on the local average value of vₚₙ, v̅ₚₙ. If v̅ₚₙ > Vₒᵤₜ, 3/3-PWM is used, and if v̅ₚₙ < Vₒᵤₜ, ⅔-PWM is used, as shown in FIGS. 15.

The DM and CM voltage analysis follows the behaviour described for ⅔-PWM and 3/3-PWM independently.

### Control Unit With Synergetic Control Structure

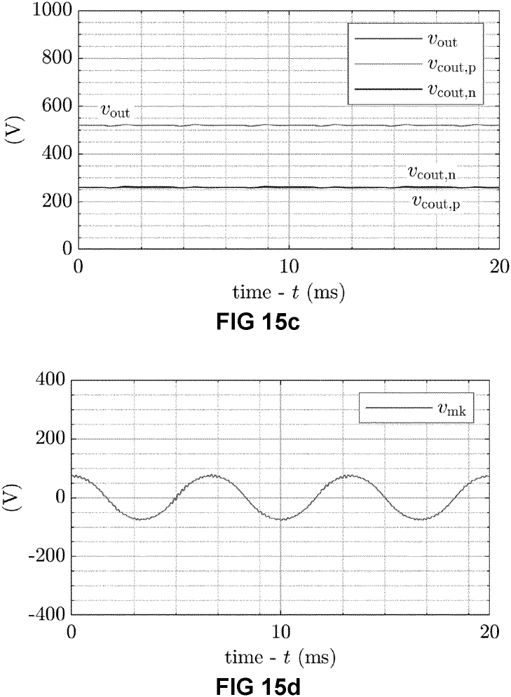

FIG. 16 shows a block diagram of control unit 20 implementing a synergetic control structure according to an aspect of the present disclosure. The control unit 20 advantageously comprises three main functional blocks 21, 22 and 23. Control unit 20 can be configured to receive as input a reference output voltage. Outputs of the control unit 20 are gate signals to the switches of the CSR stage 11, representative of a selected PWM scheme and gate signals to the switches of the DC/DC stage 12, which are particularly representative of a duty cycle which the control unit 20 has determined for these switches (in boost mode operation). On the other hand, in buck-mode operation, control unit 20 is configured to maintain DC/DC stage 12 inoperative as described above.

The first block 21 is formed by an Output Voltage Controller, and is configured to define the input power reference P*, e.g. through a PI-controller, considering the error between the actual and the reference output voltage, Vₒᵤₜ and

$${V}_{o u t}^{*} ,$$

respectively. Hence, by measuring the peak value of the three-phase mains voltages V̅_{in,meas} (constant over one mains period even for unbalanced mains conditions), the converter’s input conductance reference G* is calculated as:

$$G * = \frac{P *}{\frac{3}{2} {\hat{V}}_{i n , m e a s}^{2}}$$

and fed into the following block 22 responsible for the DC-Link Current Reference Generation.

In order to achieve PFC operation, the three-phase mains current references

$${i}_{a}^{*} , {i}_{b}^{*} ,$$

and

$${i}_{c}^{∗}$$

are set proportional to the corresponding three-phase mains voltages

$${v}_{m , a}^{*} , {v}_{m , b}^{*} ,$$

and

$${v}_{m , c}^{∗} ,$$

and are limited to lₘₐₓ to ensure the safe operation of the selected power semiconductors and to avoid the saturation of the DC-link inductor L_{DC}. The instantaneous values of these currents advantageously provide the sector information for the space vector pulse width modulator 24 of the CSR-stage 11, while the upper envelope of their absolute values

$${i}_{D C , 2 / 3}^{∗} ,$$

obtained by

$${i}_{D C , 2 / 3}^{∗} = m a x \left\{\left|{i}_{a}^{∗}\right| , \left|{i}_{b}^{∗}\right| , \left|{i}_{c}^{∗}\right|\right\} ,$$

is the varying DC-link current reference for ⅔-PWM operation. Differently, multiplying G*with the calculated peak value of the three-phase mains voltages V̅_{in,c} (different from V̅_{in,meas} only in case of unbalanced mains conditions), defined by:

$${\hat{V}}_{i n , c} = \sqrt{\frac{3}{2} \left({v}_{a}^{2} + {v}_{b}^{2} + {v}_{c}^{2}\right)} ,$$

provides the peak value of the three-phase mains current references

$${\hat{I}}_{i n}^{∗} . {\hat{V}}_{i n , c}$$

is constant and equal to V̅_{in,meas} only for symmetric mains conditions. If the mains is unbalanced, V̅_{in,c} shows a time-dependent behaviour within one switching period. The varying V̅_{in,c} ensures a sinusoidal shape of

$${I}_{D C , 3 / 3}^{∗}$$

during one-phase operation.

The DC-link current reference for 3/3-PWM operation

$${I}_{D C , 3 / 3}^{∗} ,$$

can be determined by the reference output power P* and measured phase voltages vₐ, v_{b}, v_{c}. This ensures the operation under unbalanced mains condition. Dividing

$${\hat{I}}_{i n}^{∗}$$

by the current conversion ratio of the AC/DC-stage

$${m}_{A C / D C}^{∗}$$

and of the DC/DC-stage

$${m}_{D C / D C}^{∗} ,$$

the DC-link current reference for 3/3-PWM operation

$${I}_{D C , 3 / 3}^{∗} ,$$

is calculated.

$${m}_{A C / D C}^{∗}$$

and

$${m}_{D C / D C}^{∗}$$

are derived from the reference output voltage

$${V}_{o u t}^{∗}$$

to operate with the minimum DC-link current i_{DC}. It will be convenient to note that the current conversion ratio of the AC/DC-stage can alternatively be stated as

$${m}_{A C / D C}^{∗} = \frac{{\hat{I}}_{i n}^{∗}}{{\hat{I}}_{D C}^{∗}}$$

and of the DC/DC-stage as

$${m}_{D C / D C}^{∗} = \frac{{\hat{I}}_{D C}^{∗}}{{I}_{o u t}} .$$

Therefore, as an advantage and as shown in FIG. 16, the present method advantageously allows to determine

$${I}_{D C , 3 / 3}^{∗}$$

without requiring to measure the output current lₒᵤₜ. In buck mode operation, the DC-link current reference for 3/3-PWM operation

$${I}_{D C , 3 / 3}^{∗}$$

corresponds to lₒᵤₜ.

Advantageously, the DC-link current reference

$${i}_{D C}^{∗}$$

takes the maximum value between

$${i}_{D C , 2 / 3}^{∗} , \text{and} {I}_{D C , 3 / 3}^{∗} ,$$

$${i}_{D C}^{∗} = m a x \left\{{i}_{D C , 2 / 3}^{∗} , {I}_{D C , 3 / 3}^{∗}\right\} ,$$

providing the input for the third block 23, controlling the DC-link current, and referred to as the Synergetic DC-Link Current Control. In particular, in one embodiment, automatic selection of the operating mode can be based on the value of

$${i}_{D C}^{∗} ,$$

and hence based on comparison between

$${i}_{D C , 2 / 3}^{∗} \text{and} {I}_{D C , 3 / 3}^{∗} .$$

If

$${i}_{D C , 2 / 3}^{∗}$$

is larger than lₒᵤₜ, hence larger than

$${I}_{D C , 3 / 3}^{∗} ,$$

the converter 10 operates in Boost-mode, with ⅔-PWM operation of the CSR stage 11. If smaller, the DC/DC-stage 12 does not operate, the switches T_{DC,hp} and T_{DC,hn} are permanently on, and the CSR-stage 11 operates with 3/3-PWM in Buck-mode, resulting in identical currents flowing through the DC-link inductor and at the DC output.

Advantageously, the method for determining

$${i}_{D C}^{∗}$$

shown in (4), ensures a seamless transition from 3/3-PWM to ⅔-PWM and vice versa. It furthermore advantageously ensures minimum conduction losses in Transition-mode.

In the Synergetic DC-Link Current Control block 23,

$${i}_{D C}^{∗}$$

is first compared with

$${i}_{D C} = \frac{1}{2} \left({i}_{D C , p} + {i}_{D C , n}\right) ;$$

their difference, e.g. by means of the DC-link current PI-controller, provides the voltage

$${v}_{L}^{∗}$$

to be generated across L_{DC} by switching the CSR-stage 11 and possibly the DC/DC-stage 12. The sum of

$${v}_{L}^{∗}$$

and the output voltage reference

$${V}_{o u t}^{∗}$$

results in the virtual DC-link voltage reference

$${V}_{D C}^{∗} .$$

Feeding

$${V}_{D C}^{∗}$$

into two voltage limiters, the virtual DC-link voltage references for 3/3-PWM

$${v}_{D C , 3 / 3}^{∗}$$

and for ⅔-PWM

$${v}_{D C , 2 / 3}^{∗}$$

are calculated. This is the core of the synergetic operation; in fact, when the three-phase mains voltages are large enough to generate the necessary

$${V}_{D C}^{∗}$$

without operating the DC/DC-stage, i.e.

$${V}_{o u t}^{∗} < {V}_{max} ,$$

this stage is permanently clamped to eliminate its switching losses, while the CSR-stage provides the required voltage gain (Buck-mode), but must operate with 3/3-PWM. In this case,

$${v}_{D C , 3 / 3}^{∗} = {v}_{D C}^{∗} = {v}_{p n}^{∗} ,$$

i.e. the reference output voltage of the CSR-stage, and

$${v}_{D C , 2 / 3}^{∗} = {V}_{o u t}^{∗} .$$

Differently, when

$${V}_{o u t}^{∗}$$

is large enough to balance the volt-second area applied to Loc by the CSR-stage with m_{AC/DC} = 1, i.e.

$${V}_{o u t}^{∗} > \frac{2}{\sqrt{3}} {V}_{max} ,$$

the CSR-stage operates with ⅔-PWM and the DC/DC-stage is actively switched with PWM (Boost-mode). Specifically,

$${v}_{D C , 3 / 3}^{∗} = {V}_{m a x} ,$$

and

$${v}_{D C , 2 / 3}^{∗} = {v}_{q r}^{∗} ,$$

i.e. the reference input voltage of the DC/DC-stage. Finally, when

$${V}_{max} < {V}_{o u t}^{∗} <$$

$$\frac{2}{\sqrt{3}} {V}_{m a x} ,$$

the current controller democratically switches between ⅔-PWM and 3/3-PWM, depending on the instantaneous

$${v}_{L}^{∗}$$

(Transition-mode).

Accordingly, the current control block 23 advantageously regulates the DC-link current i_{DC} always by means of only one stage, i.e. when operating with 3/3-PWM, the CSR-stage 11 is controlled by modifying

$${v}_{D C , 3 / 3}^{∗}$$

and

$${v}_{D C , 2 / 3}^{∗}$$

is not influenced thanks to the voltage limiter; when operating with ⅔-PWM, instead, the DC/DC-stage 12 is controlled by modifying’

$${v}_{D C , 2 / 3}^{∗}$$

and

$${v}_{D C , 3 / 3}^{∗}$$

is clamped to Vₘₐₓ.

To ultimately operate the two stages,

$${v}_{D C , 3 / 3}^{∗}$$

and

$${v}_{D C , 2 / 3}^{∗}$$

are fed to the modulators 24, 25. For the CSR-stage, the reference DC-link current

$${i}_{D C , C S R}^{∗}$$

utilized in the modulator 24 is determined based on

$${v}_{D C , 3 / 3}^{∗}$$

and on m_{DC/DC}.

$${i}_{D C , C S R}^{∗}$$

and

$${i}_{D C}^{∗}$$

are identical in steady state. Specifically, in 3/3-PWM operation,

$${V}_{o u t}^{∗}$$

coincides with

$${v}_{q n}^{∗} = {v}_{D C , 3 / 3}^{∗}$$

and

$${m}_{D C / D C}^{∗} = 1$$

because T_{DC,hp} and T_{DC,hn} are permanently on. Differently, in ⅔-PWM operation,

$${m}_{D C / D C}^{∗}$$

must be considered due to the operation of the DC/DC stage. Given

$$\frac{{V}_{o u t}^{∗}}{{m}_{D C / D C}^{∗} ⋅ {V}_{m a x}} = 1$$

the CSR-stage operates with the maximum modulation index, and

$${i}_{D C}^{∗}$$

is regulated by the DC/DC-stage only. The switching signals for the CSR-stage 11 can be calculated from

$${i}_{a}^{∗} , {i}_{b}^{∗} ,$$

$${i}_{c}^{∗} ,$$

and

$${i}_{D C , C S R}^{∗}$$

as described in reference [4] and appropriately distributed to the twelve gate terminals.

An example is given in the following considering the sector where phase c has the minimum current value (see FIG. 7). The zero state used in this sector is [bb] from

$$\frac{π}{6} \text{to} \frac{π}{3}$$

and [aa] from

$$\frac{π}{3} \text{to} \frac{π}{2} ,$$

instead of [cc] as in the PWM schemes described in the prior art. The duty cycles of the two active states and of the zero state are calculated as:

$${δ}_{\left[a c\right]} = \frac{{i}_{a}^{∗}}{{i}_{D C}^{∗}} , {δ}_{\left[b c\right]} \frac{{i}_{a}^{∗}}{{i}_{D C}^{∗}} , a n d {δ}_{\left[0\right]} = 1 - {δ}_{\left[a c\right]} - {δ}_{\left[b c\right]} ,$$

where δ_{[xy]} indicates the duty cycle of the state [xy].

Finally, the duty-cycle reference of the DC/DC-stage 12 is calculated by:

$$d * = \frac{{v}_{D C , 2 / 3}^{∗}}{{V}_{o u t}^{∗}} = \frac{{v}_{q n}^{∗}}{{V}_{o u t}^{∗}}$$

and then compared with a three-level triangular carrier to generate complementary switching signals.

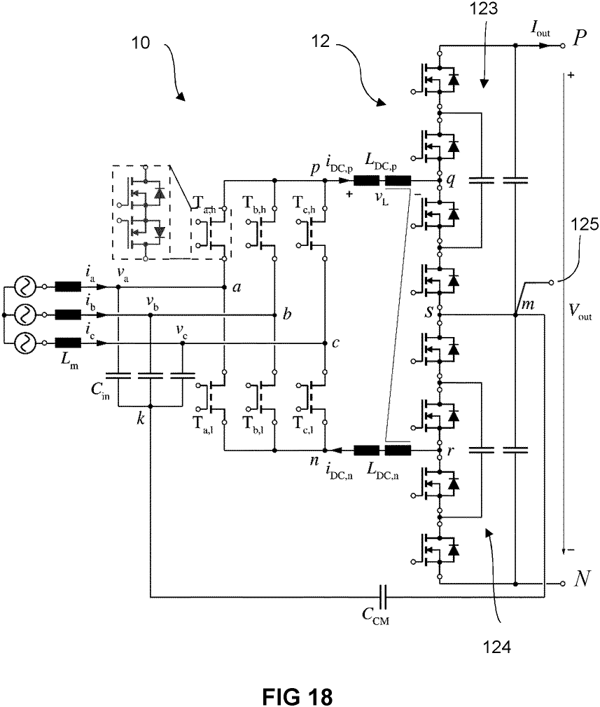

Referring to FIG. 19, a battery charging system 700 comprises a power supply unit 704. The power supply unit 704 is coupled on one side to the AC grid through terminals A, B, C, and on the other side (at terminals P′, N′) to an interface 702, e.g. comprising a switch device, which allows to connect the power supply unit 704 to a battery 703. The power supply unit 704 comprises any one of the electrical converter 10 as described hereinabove with first and second converter stages and further can comprise a third converter stage 701, which in the present system is a DC-DC converter, e.g. an LLC resonant converter. The power supply unit 704, e.g. the third converter stage 701, can comprise a pair of coils which are inductively coupled through air (not shown), such as in the case of wireless power transfer. Alternatively, the DC-DC converter stage 701 can comprise or consist of an isolated DC-DC converter. In some cases, the interface 702 can comprise a plug and socket, e.g. in wired power transfer. Alternatively, the plug and socket can be provided at the input (e.g., at nodes A, B, C).

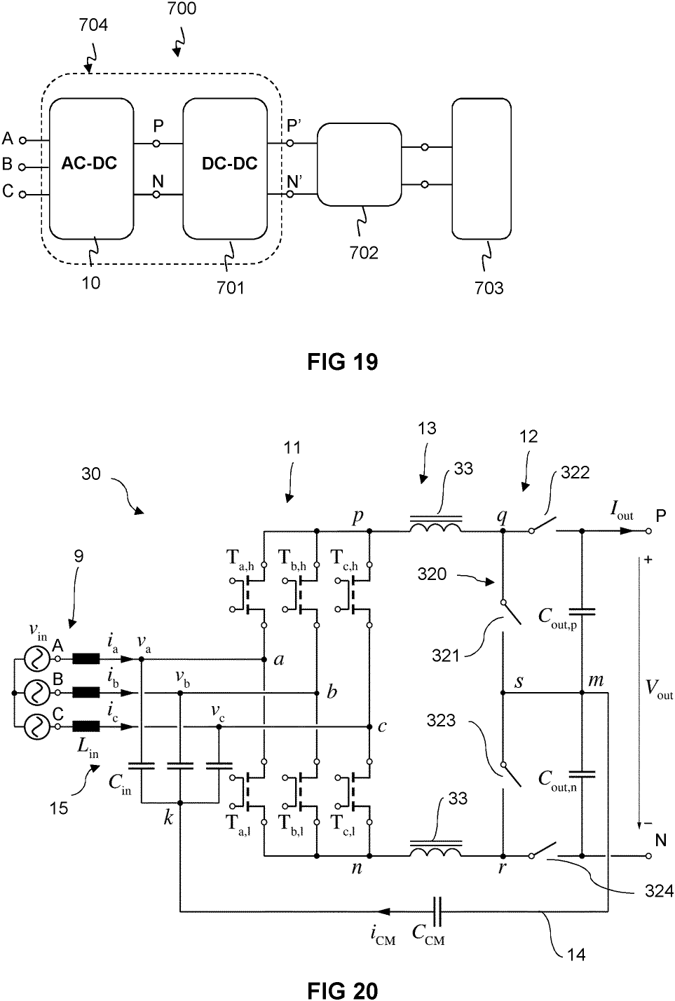

Referring to FIG. 20, an electric motor drive system 30 can incorporate the electrical converter as described herein. In an advantageous embodiment, the stator coils 33 of an electric motor (not shown) are connected to act as a common mode filter choke and/or as a differential mode inductor of the DC link 13. Additionally, or alternatively, the second converter stage 12 can be configured to operate as a traction inverter of the electric motor. The traction inverter can be formed by the half bridge 320 between nodes q and r. Switches 321, 322, 323, 324 can be semiconductor switches, e.g. just as switches T_{DC,vp}, T_{DC,hp}, T_{DC,vn} and T_{DC,hn} respectively of FIG. 1.

Aspects of the present disclosure are set out in the following numbered clauses.

1. Electrical converter for converting between an AC signal having at least three phases and a DC signal, comprising:
at least three phase terminals, a first DC terminal and a second DC terminal,
a first converter stage operably coupled to the at least three phase terminals and comprising a first intermediate node (p) and a second intermediate node (n), wherein the converter stage is operable to convert between an AC current at the at least three phase terminals and a first DC current at the first and second intermediate nodes (p, n),
a second converter stage operably coupled to the first DC terminal and the second DC terminal and comprising a third intermediate node (q) and a fourth intermediate node (r), wherein the second converter stage is operable to convert between a first DC signal at the third and fourth intermediate nodes (q, r) and a second DC signal at the first and second DC terminals, wherein the second converter stage comprises a middle voltage node (m) between the first and second DC terminals,
a first filter stage comprising a capacitor network (Cᵢₙ) operably coupled to each of the three phase terminals, wherein the capacitor network comprises a star-point (k),
a DC link connecting the first intermediate node (p) to the third intermediate node (q) and the second intermediate node (n) to the fourth intermediate node (r),
wherein the DC link comprises a common mode filter, the common mode filter comprising a common mode capacitor (C_{CM}) connecting the middle voltage node (m) to the star-point (k).

2. Electrical converter of clause 1, wherein the common mode filter comprises a common mode filter choke operably coupled to the first intermediate node (p) and the second intermediate node (n), the third intermediate node (q) and the fourth intermediate node (r).

3. Electrical converter of clause 1 or 2, wherein the DC link comprises at least one differential mode inductor operably coupled to the first intermediate node (p) and the third intermediate node (q) and/or operably coupled to the second intermediate node (n) and the fourth intermediate node (r).

4. Electrical converter of clauses 2 and 3, wherein the common mode filter choke and the differential mode inductor comprise a common core or individual cores.

5. Electrical converter of any one of the preceding clauses, wherein the first DC signal is the first DC current.

6. Electrical converter of any one of the preceding clauses, wherein the second DC signal is a DC voltage across the first and second DC terminals.

7. Electrical converter of any one of the preceding clauses, wherein the first filter stage comprises inductors (Lₘ) coupled between the three phase terminals and the capacitor network (Cᵢₙ).

8. Electrical converter of any one of the preceding clauses, wherein the second converter stage comprises a capacitor filter (C_{out,p}, C_{out,n}) comprising a plurality of series connected capacitors across the first and second DC terminals, wherein the middle voltage node (m) is a middle node of the capacitor filter.

9. Electrical converter of any one of the preceding clauses, wherein the second converter stage comprises a boost circuit.

10. Electrical converter of clause 9, wherein the second converter stage comprises a plurality of series connected first switches (T_{DC,vp}, T_{DC,vn}) connected between the third intermediate node (q) and the fourth intermediate node (r), wherein a midpoint of the series connected first switches is connected to the middle voltage node (m).

11. Electrical converter of clause 9 or 10, wherein the boost circuit comprises a first boost circuit (T_{DC,hp}, T_{DC,vp}) and a second boost circuit (T_{DC,hn}, T_{DC,vn}) stacked between the first DC terminal and the second DC terminal, wherein the middle voltage node (m) is a common node of the first and second boost circuits.

12. Electrical converter of clause 11, wherein the first boost circuit and/or the second boost circuit is a multi-level boost circuit.

13. Electrical converter of any one of the preceding clauses, comprising a third DC terminal connected to the middle voltage node (m).

14. Electrical converter of any one of the preceding clauses, comprising a control unit, wherein the first converter stage and the second converter stage comprise active switching devices operably coupled to the control unit, wherein the control unit is implemented with a plurality of operating modes for operating the electrical converter.

15. Electrical converter of clause 14, wherein a first operating mode of the plurality of operating modes corresponds to a buck mode of operation, wherein the second converter stage is configured to operate to continuously connect the third and fourth intermediate nodes (q, r) to the first and second DC terminals respectively, and wherein the control unit is configured to actively operate the active switching devices (T_{a,h}, T_{a,l}, T_{b,h}, T_{b,l}, T_{c,h}, T_{c,l}) of the first converter stage.

16. Electrical converter of clause 14 or 15, wherein a second operating mode of the plurality of operating modes corresponds to a boost mode of operation, wherein the control unit is configured to actively operate the active switching devices (T_{a,h}, T_{a,l}, T_{b,h}, T_{b,l}, T_{c,h}, T_{c,l}, T_{DC,hp}, T_{DC,vp}, T_{DC,hn}, T_{DC,vn}) of both the first converter stage and the second converter stage.

17. Electrical converter of any one of the clauses 14 to 16, wherein the control unit is operable to operate the electrical converter in rectifier mode, wherein in rectifier mode, the control unit is operable to determine a first current reference

$$\left({i}_{D C , 2 / 3}^{∗}\right)$$

for a current in the DC link and a second current reference

$$\left({I}_{D C , 3 / 3}^{∗}\right)$$

for the current in the DC link, wherein the control unit is operable to automatically select between the plurality of operating modes based on comparison of the first current reference and the second current reference.

18. Electrical converter of clause 17, wherein the first current reference is determined based on a reference output power and reference input phase currents.

19. Electrical converter of clause 17 or 18, wherein the second current reference is determined based on a reference output power and measured phase voltages.

20. Electrical converter of any one of the clauses 14 to 19, wherein the control unit is configured to operate the active switching devices through pulse width modulation.

21. Electrical converter of any one of the clauses 14 to 20, wherein the control unit is configured to operate the first converter stage and the second converter stage so as to obtain a voltage across the common mode capacitor (C_{CM}) being one of: a substantially constant zero voltage signal, a substantially triangular waveform and a substantially sinusoidal waveform, preferably comprising one or more harmonic frequencies of a fundamental frequency of the AC signal, preferably comprising a third harmonic frequency of the fundamental frequency.

22. Electrical converter of any one of the preceding clauses, wherein the control unit is operable to inject a common mode voltage signal to the third and fourth intermediate nodes (q, r) so as to control a voltage across the common mode capacitor (C_{CM}).

23. Electrical converter of clause 22, comprising measurement means for measuring a voltage signal at the middle voltage node (m) and at nodes (a, b, c) of the at least three phases, wherein the controller is operable to determine the common mode voltage signal injected to the third and fourth intermediate nodes (q, r) based on the measured voltage signals.

24. Electrical converter of clause 22 or 23, wherein the control unit is operable to add an offset to duty cycles of pulse width modulation signals controlling operation of active switches (T_{DC,vp}, T_{DC,vn}) of the second converter stage, thereby obtaining the common mode voltage signal injected to the third and fourth intermediate nodes (q, r).

25. Electric motor drive system, comprising the electrical converter of any one of the preceding clauses.

26. Electric motor drive system according to clause 25, further comprising an electric motor comprising stator coils, wherein the stator coils are connected to act as a common mode filter choke and/or as a differential mode inductor of the DC link of the electrical converter.

27. Electric motor drive system according to clause 25 or 26, comprising a traction inverter operable to drive the electric motor, wherein the traction inverter is configured to operate as the second converter stage when operating the electrical converter.

28. Battery charging system, in particular for charging electric vehicle drive batteries, wherein the battery charging system comprises a power supply, the power supply comprising the electrical converter of any one of the clauses 1 to 24.

29. Method of converting between an AC signal having at least three phases at at least three phase nodes (a, b, c) and a DC signal at a high node (p) and a low node (n), comprising switching by pulse width modulation between the at least three phase nodes (a, b, c) and the high node (p) and the low node (n) to obtain a switched voltage signal across the high node and low node, wherein a period of the switched voltage signal comprises a zero voltage level portion obtained by connecting the phase node having a smallest absolute instantaneous voltage value of the at least three phases of the AC signal to both the high node (p) and the low node (n).

30. Method of clause 29, wherein the switched voltage signal comprises a second voltage level portion obtained by connecting the phase node having the highest instantaneous voltage value of the at least three phases of the AC signal to the high node (p), and connecting the phase node having the lowest instantaneous voltage value of the at least three phases of the AC signal to the low node (n).

31. Method of clause 29 or 30, wherein the switched voltage signal comprises a third voltage level portion obtained by connecting the phase node having the smallest absolute instantaneous voltage value to the high node, and connecting the phase node having the lowest instantaneous voltage value of the at least three phases of the AC signal to the low node.

32. Method of any one of the clauses 29 to 31, applied to the electrical converter of any one of the clauses 1 to 24.

33. Electrical converter of any one of the clauses 1 to 24, comprising a control unit configured for operating the first converter stage according to the method of any one of the clauses 29 to 31.

1. An electrical converter for converting between an AC signal having at least three phases and a DC signal, the electrical converter comprising:
at least three phase terminals (A, B, C), a first DC terminal (P), and a second DC terminal (N),
a first converter stage operably coupled to the at least three phase terminals and comprising a first intermediate node (p) and a second intermediate node (n), wherein the first converter stage is operable to convert between an AC current at the at least three phase terminals and a first DC current (i_{DC,p}, i_{DC,n}) at the first and second intermediate nodes (p, n),
a second converter stage operably coupled to the first DC terminal (P) and the second DC terminal (N) and comprising a third intermediate node (q), a fourth intermediate node (r) and a middle voltage node (m) between the first and second DC terminals, wherein the second converter stage is operable to convert between a first DC signal at the third and fourth intermediate nodes (q, r) and a second DC signal at the first and second DC terminals, wherein the second converter stage comprises a boost circuit comprising a plurality of first switches (T_{DC,vp}, T_{DC,vn}) series connected between the third intermediate node (q) and the fourth intermediate node (r), wherein a midpoint (s) of the series connected first switches is connected to the middle voltage node (m) so as to be at a same electrical potential as the middle voltage node,
a first filter stage comprising a capacitor network (Cᵢₙ) operably coupled to each of the three phase terminals, wherein the capacitor network comprises a star-point (k),
a DC link connecting the first intermediate node (p) to the third intermediate node (q) and the second intermediate node (n) to the fourth intermediate node (r),
wherein the DC link comprises a common mode filter,
a control unit, wherein the first converter stage and the second converter stage comprise active switching devices operably coupled to the control unit, wherein the control unit is implemented with a plurality of operating modes for operating the electrical converter,
wherein the control unit is operable to operate the electrical converter in rectifier mode, wherein in rectifier mode, the control unit is operable to determine a first current reference (i*_{DC,⅔}) for a current in the DC link and a second current reference (I*_{DC,3/3}) for the current in the DC link, wherein the control unit is operable to automatically select between the plurality of operating modes based on comparison of the first current reference and the second current reference, and
wherein the common mode filter comprises a common mode capacitor (C_{CM} ) connecting the middle voltage node (m) to the star-point (k).

2. The electrical converter of claim 1, wherein the common mode filter comprises a common mode filter choke (L_{DC,CM}) operably coupled to the first intermediate node (p) and the second intermediate node (n), the third intermediate node (q) and the fourth intermediate node (r).

3. The electrical converter of claim 1, wherein the DC link comprises at least one differential mode inductor (L_{DC,DM}) operably coupled to the first intermediate node (p) and the third intermediate node (q) and/or operably coupled to the second intermediate node (n) and the fourth intermediate node (r).

4. (canceled)

5. The electrical converter of claim 1, wherein the first DC signal is the first DC current (i_{DC,p}, i_{DC,n}) and the second DC signal is a DC voltage (Vₒᵤₜ) across the first and second DC terminals.

6-7. (canceled)

8. The electrical converter of claim 1, wherein the second converter stage comprises a plurality of-output capacitors (C_{out,p}, C_{out,n}) series connected across the first and second DC terminals, wherein the middle voltage node (m) is a middle node of the plurality of output capacitors.

9. The electrical converter of claim 1, wherein the boost circuit comprises a first boost circuit and a second boost circuit stacked between the first DC terminal (P) and the second DC terminal (N), wherein the middle voltage node (m) is a common node of the first and second boost circuits.

10. (canceled)

11. The electrical converter of claim 1, further comprising a third DC terminal connected to the middle voltage node (m).

12. The electrical converter of claim 1, wherein a first operating mode of the plurality of operating modes corresponds to a buck-mode of operation, wherein the second converter stage is configured to operate to continuously connect the third and fourth intermediate nodes (q, r) to the first and second DC terminals respectively, and wherein the control unit is configured to operate the active switching devices (T_{a,h}, T_{a,l}, T_{b,h}, T_{b,l}, T_{c,h}, T_{c,l}) of the first converter stage through pulse width modulation.

13. The electrical converter of claim 12, wherein in the first operating mode, the control unit is configured to operate the active switching devices of the first converter stage according to a pulse-width modulation scheme switching between active states in which two phases of the at least three phases are connected to the first and second intermediate nodes (p, n) and zero states in which the first and second intermediate nodes (p, n) are short-circuited, wherein the control unit is configured to implement the zero states by connecting a phase of the at least three phases of the AC signal having a smallest absolute instantaneous voltage value to the first and second intermediate nodes (p, n).

14. The electrical converter of claim 1, wherein a second operating mode of the plurality of operating modes corresponds to a boost mode of operation, wherein the control unit is configured to operate the active switching devices (T_{a,h}, T_{a,l}, T_{b,h}, T_{b,l}, T_{c,h}, T_{c,l}, T_{DC,hp}, T_{DC,vp}, T_{DC,hn}, T_{DC,vn}) of both the first converter stage and the second converter stage through pulse width modulation.

15. The electrical converter of claim 14, wherein in the second operating mode, the control unit is configured to operate the active switching devices of the first converter stage according to a pulse-width modulation scheme being free of zero states in which the first and the second intermediate nodes are short circuited by the active switches of the first converter stage.

16. The electrical converter of claim 1, wherein the first current reference is determined based on a reference output power and reference input phase currents and wherein the second current reference is determined based on a reference output power and measured phase voltages.

17. (canceled)

18. The electrical converter of claim 1, wherein the control unit is configured to operate the first converter stage and the second converter stage so as to obtain a voltage across the common mode capacitor (C_{CM}) being one of: a substantially constant zero voltage signal, a substantially triangular waveform, a substantially sinusoidal waveform, and a sinusoidal waveform comprising a third harmonic frequency of a fundamental frequency.

19. The electrical converter of claim 1, wherein the control unit is operable to inject a common mode voltage signal to the third and fourth intermediate nodes (q, r) so as to control a voltage across the common mode capacitor (C_{CM}), wherein the control unit is operable to add an offset to duty cycles of pulse width modulation signals controlling operation of active switches (T_{DC,vp}, T_{DC,vn}) of the second converter stage, thereby obtaining the common mode voltage signal injected to the third and fourth intermediate nodes (q, r).

20-22. (canceled)

23. An electric motor drive system comprising the electrical converter of claim 1, further comprising an electric motor comprising stator coils, wherein the stator coils are connected to act as a common mode filter choke and/or as a differential mode inductor of the DC link of the electrical converter.

24. An electric motor drive system comprising the electrical converter of claim 1, further comprising a traction inverter operable to drive the electric motor, wherein the traction inverter is configured to operate as the second converter stage when operating the electrical converter.

25. A battery charging system, wherein the battery charging system comprises a power supply, the power supply comprising the electrical converter of claim 1.

26. A method of converting between an AC signal having at least three phases at at least three phase nodes (a, b, c) and a DC signal at a high node (p) and a low node (n), the method comprising:
providing the electrical converter of claim 1, and
switching by pulse width modulation between the at least three phase nodes (a, b, c) and the high node (p) and the low node (n) to obtain a switched voltage signal across the high node and low node,
wherein a period of the switched voltage signal comprises a zero voltage level portion obtained by connecting the phase node having a smallest absolute instantaneous voltage value of the at least three phases of the AC signal to both the high node (p) and the low node (n).

27. The method of claim 26, wherein the switched voltage signal comprises a second voltage level portion obtained by connecting the phase node having the highest instantaneous voltage value of the at least three phases of the AC signal to the high node (p), and connecting the phase node having the lowest instantaneous voltage value of the at least three phases of the AC signal to the low node (n).

28. The method of claim 26, wherein the switched voltage signal comprises a third voltage level portion obtained by connecting the phase node having the smallest absolute instantaneous voltage value to the high node, and connecting the phase node having the lowest instantaneous voltage value of the at least three phases of the AC signal to the low node, or vice versa.
